(19) United States
(12) Patent Application Publication
(10) Pub. No.: US 2025/0315804 A1
(43) Pub. Date: Oct. 9, 2025

(54) TRANSACTION APPARATUS OF CRYPTOCURRENCY AND MANAGEMENT METHOD FOR THE TRANSACTION APPARATUS OF CRYPTOCURRENCY

(71) Applicant: GWANGJU INSTITUTE OF SCIENCE AND TECHNOLOGY, Gwangju (KR)

(72) Inventors: Haeung Choi, Gwangju (KR); Heung-No Lee, Gwangju (KR); Jusung Kang, Gwangju (KR); Sumin Kim, Gwangju (KR)

(21) Appl. No.: 19/080,664

(22) Filed: Mar. 14, 2025

(30) Foreign Application Priority Data
Apr. 3, 2024 (KR) 10-2024-0045254

(51) Int. Cl. G06Q 20/06; G06Q 20/38; G06Q 20/40

(52) U.S. Cl. CPC G06Q 20/0658; G06Q 20/3825; G06Q 20/405

(57) ABSTRACT

The transaction method of the cryptocurrency may include acquiring the price information on the actual asset exchange from the information collection node and submitting the price information to the transaction apparatus of the cryptocurrency when a user node requests the transaction of the cryptocurrency.

### CROSS-REFERENCE TO RELATED APPLICATIONS

The present application claims priority under 35 U.S.C. 119 and 35 U.S.C. 365 to Korean Patent Application No. 10-2024-0045254 (filed on Apr. 3, 2024), which is hereby incorporated by reference in its entirety.

### BACKGROUND

The present disclosure relates to a transaction apparatus of a cryptocurrency and a management method for the transaction apparatus of the cryptocurrency.

Cryptocurrencies may be transacted. An example of a transaction market of the cryptocurrencies transaction market may include decentralized exchange (DEX). In the transaction market of the cryptocurrencies, liquidity providers (LPs) may deposit assets. Herein, the assets may be the cryptocurrencies. Users may transact assets instantly by utilizing liquidity provided by the liquidity providers. The users may pay liquidity fees to the liquidity providers for each transaction on the asset exchange. When the transaction in asset exchanges, a certain price determination algorithm (automated market (AMM): maker) may determine the price of the asset exchange.

The price suggested by the price determination algorithm may be different from an actual asset exchange price. Thus, transaction profits may occur. If the transaction profits occur, the liquidity provider may incur a loss equivalent to the profits of the arbitrageur. The loss is defined as an impermanent loss (IL). The impermanent loss is a factor that hinders the transaction of the cryptocurrencies.

As a solution to the above-described impermanent loss, a non-patent document (dynamic curves for decentralized autonomous cryptocurrency exchanges) has been proposed. The non-patent document may report a market price of an asset in real time using a price determination algorithm. Thus, the price determination algorithm may dynamically calculate a transaction price according to the market price. As a result, there may be no impermanent loss.

However, there is a limitation in that blockchain transaction fees (transmission fees: Tx fees) occur to report the market price of the asset in real time. The transaction fees are paid to block validators or miners of the blockchain. The transaction fees on the blockchain may be amount to significant amounts. Managers of cryptocurrency exchange markets need to upload the market price every block. For example, in the case of Ethereum, blockchain transaction fees exceeding about 1.4 million won per day may occur to report the market price of the asset. The transaction fees on the blockchain may occur even if there are no cryptocurrency transaction.

### PRIOR ART DOCUMENT

### Non-Patent Document

Dynamic Curves for Decentralized Autonomous Cryptocurrency: Exchanges arXiv:2101.02778v1 [q-fin.TR] 7 Jan. 2021

### SUMMARY

The present disclosure is proposed under the above background.

The present disclosure also proposes a transaction apparatus of a cryptocurrency, which is capable of reducing transaction fees of a blockchain that reports the market price of an asset, and a management method for the transaction apparatus of the cryptocurrency.

The present disclosure also proposes a transaction apparatus of a cryptocurrency, which is capable of reducing a loss of a manager in a cryptocurrency transaction market, and a management method for the transaction apparatus of the cryptocurrency.

The present disclosure also proposes a transaction apparatus of a cryptocurrency, which is capable of promoting cryptocurrency transaction, and a management method for the transaction apparatus of the cryptocurrency.

In one embodiment, a transaction apparatus of a cryptocurrency may include a verification unit configured to input price information of an actual asset exchange of an asset, for which a transaction is requested, information on a block including a timestamp and a digital signature, and perform verification of the digital signature. The transaction apparatus of the cryptocurrency may include an update unit configured to update the latest information on the current time of the asset by using the information contained in the information of the block. The transaction apparatus of the cryptocurrency may include an impermanent loss measurement unit configured to measure an impermanent loss corresponding to a delay time, which is a difference between the delay time corresponding to the timestemp and the current time, by using the information of the block output from the verification unit, and configured to determine whether to perform a transaction of the asset in response to the transaction request by using the measured impermanent loss.

The information of the block may be transmitted to the verification unit together with information on the transaction request, in which a user requests the transaction.

The transaction apparatus of the cryptocurrency may include a rejection sequence unit configured to reject the transaction request in at least one of a case, in which the verification of the digital signature fails in the verification unit, or a case, in which the impermanent loss measured in the impermanent loss measurement unit exceeds a maximum allowable value of the impermanent loss.

The transaction apparatus of the cryptocurrency may include an execution sequence unit configured to execute the transaction request when it is satisfied that the digital signature is verified in the verification unit, and the impermanent loss measured in the impermanent loss measurement unit does not exceed the maximum allowable value of impermanent loss.

The impermanent loss measurement unit may be configured to measure the impermanent loss that occurs when executing the transaction request using the latest information output from the update unit.

At least one of a case, in which as the maximum allowable impermanent loss increases, an allowable range for the delay time increases, a case, in which the larger a confidence interval, the smaller the allowable range of the delay time, a case in which as a standard deviation increases, the allowable range of the delay time decreases, or a case in which the larger a price of the asset, the greater the allowable range of the delay time may be satisfied.

In another embodiment, a transaction system of a cryptocurrency may include: at least one confidence information provision mode configured to provide reliable price information of the asset; an information collection node configured to collect price information on actual asset exchange of the asset from the confidence information provision node; and a user node configured to transmit the price information on the actual asset exchange to a transaction apparatus of cryptocurrency from the information collection node to acquire the transaction of the asset as necessary.

In further another embodiment, a transaction method of a cryptocurrency may include collecting and storing price information of an actual asset exchange from a confidence information provision node through an information collection node. The transaction method of the cryptocurrency may include acquiring the price information on the actual asset exchange from the information collection node and submitting the price information to the transaction apparatus of the cryptocurrency when a user node requests the transaction of the cryptocurrency. In the transaction method of the cryptocurrency, the transaction apparatus of the cryptocurrency may determine whether to perform transaction by referring to the impermanent loss.

The transaction method of the cryptocurrency may include acquiring the price information on the actual asset exchange and submitting the acquired price information to the transaction apparatus of the cryptocurrency.

### BRIEF DESCRIPTION OF THE DRAWINGS

FIG. 1 is a transaction system in which a transaction apparatus of a cryptocurrency is managed according to the present disclosure.

FIG. 2 is a flowchart for explaining a management method for the transaction apparatus of the cryptocurrency according to the present disclosure.

FIGS. 3 and 4 are views for explaining an operation of each node, FIG. 3 is a view for explaining an operation of an information collection node, and FIG. 4 is a view for explaining an operation of a user node.

FIG. 5 is a view for explaining a configuration of the transaction apparatus of the cryptocurrency.

FIG. 6 is a timeline illustrating a critical range that allows for delay in transaction request.

FIG. 7 is a view illustrating a maximum allowable value of an impermanent loss.

### DETAILED DESCRIPTION OF THE EMBODIMENTS

Hereinafter, exemplary embodiments will be described in detail with reference to the accompanying drawings. The invention may, however, be embodied in many different forms and should not be construed as being limited to the embodiments set forth herein, and a person of ordinary skill in the art, who understands the spirit of the present invention, may readily implement other embodiments included within the scope of the same concept by adding, changing, deleting, and adding components; rather, it will be understood that they are also included within the scope of the present invention. In the description of drawings, identical or similar components are given the same reference numbers regardless of the drawing symbols, and duplicated descriptions thereof may be omitted. The suffixes “module” and “unit” for components used in the description below are assigned or mixed in consideration of easiness in writing the specification and do not have distinctive meanings or roles by themselves. In description of embodiments disclosed in this specification, detailed descriptions related to well-known functions or configurations will be ruled out in order not to unnecessarily obscure subject matters of the present invention. However, this does not limit the present invention within specific embodiments and it should be understood that the present invention covers all the modifications, equivalents, and replacements within the idea and technical scope of the present invention. It will be understood that although the ordinal numbers such as first and second are used herein to describe various elements, these elements should not be limited by these numbers. The terms are only used to distinguish one component from other components. It will also be understood that when an element is referred to as being “connected to” or “engaged with” another element, it can be directly connected to the other element, or intervening elements may also be present. It will also be understood that when an element is referred to as being ‘directly connected to’ another element, there is no intervening elements. The terms of a singular form may include plural forms unless referred to the contrary. The meaning of ‘include’ or ‘comprise’ specifies a property, a figure, a step, an operation, an element, a component, or a combination thereof, but does not exclude other properties, figures, steps, operations, elements, or their components.

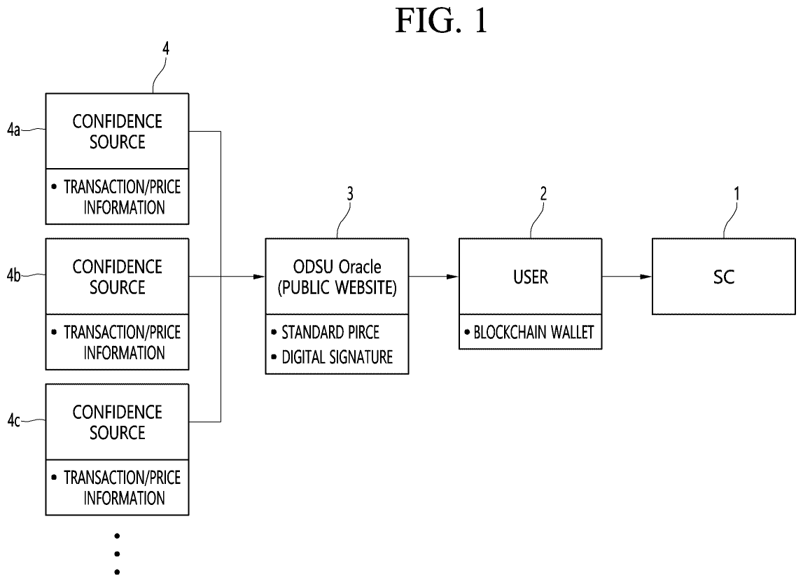

FIG. 1 is a transaction system in which a transaction apparatus of a cryptocurrency is managed according to the present disclosure.

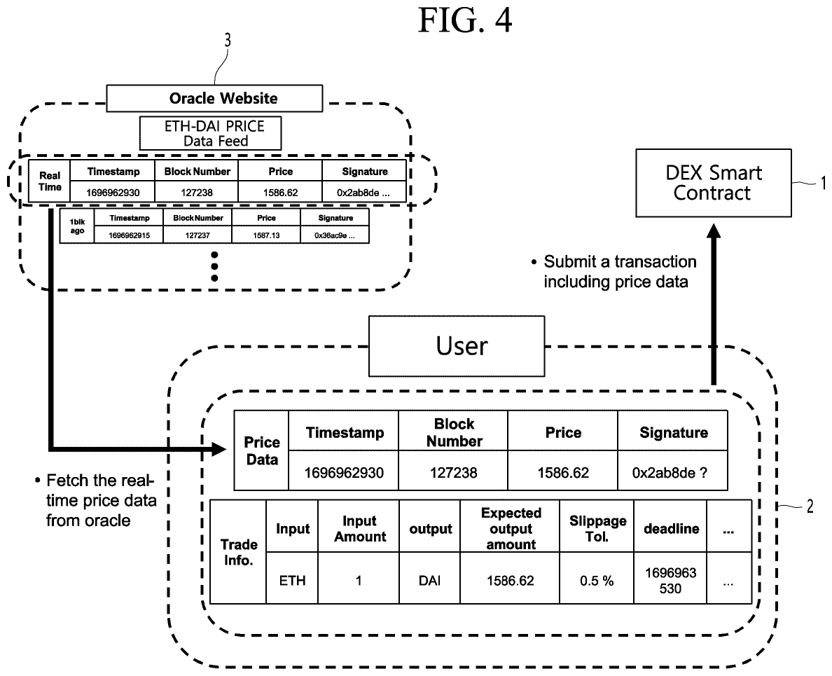

Descriptions will be made with reference to FIG. 1. The transaction system may include a transaction apparatus 1 of a cryptocurrency. The transaction apparatus 1 of the cryptocurrency may include a smart contract (SC). The transaction of the cryptocurrency may be performed by the smart contract. The detailed configuration of the smart contract will be described later with reference to FIG. 5. The transaction apparatus of the cryptocurrency may be provided with a configuration such as a memory in which account information for performing the cryptocurrency transaction is stored, a computational device, an input/output device, and an output device. The smart contract may be managed by the above-described configurations.

The transaction system may include a user node 2. The node may include a terminal used by a user. The node may include a computer. The computer may include the computational device, a storage device, the I/O device, and a communication device. The transaction system may include an information collection node 3. The user node may request cryptocurrency transactions as necessary.

The information collection node may collect and store a price of an actual asset exchange. For example, the information collection node may store real asset exchange prices for Ethereum (ETH) and DAI that is an Ethereum's stablecoin. For example, the price of the asset exchange may include an exchange rate of Ethereum (ETH) and DAI. The price of the actual asset exchange may be price information that is actually used in a market. The information collection node may be called an on-demand & self-uploading (ODSU) oracle. This is because of proving the price for the actual asset exchange. The information provision node 3 may not need to upload the price of the actual asset exchange when there is no transaction request from the user node. The information provision node 3 may collect and store the price of the actual asset exchange for each block even when there is no transaction request from the user node. The information provision node 3 may upload the price of the actual asset exchange when the transaction is requested from the user node 2. Thus, unnecessary blockchain fees and Tx fees may not occur.

The transaction system may include at least one confidence information provision node 4a, 4b, 4c. The confidence information provision node may include a plurality of nodes. The price information of the actual asset exchange provided by the confidence information provision node 3 may be collected by the information collection node 3. the information collection node 3 may store information provided by the confidence information provision node 3. The information collection node 3 may provide price information on the actual asset exchange to the user node 2 when the user node 2 requests the transaction.

The operation of the transaction system will be briefly described.

The information collection node 3 may not upload the price information on the actual asset exchanges when there are no transaction. A manager of the cryptocurrency exchange market may not need to pay management fees of the unnecessary blockchain such as Tx fees. The cryptocurrency transaction market may be more activated. The information collection node 3 may collect and store the price information on the actual asset exchange from the confidence information provision node 4 when there is no transaction request. There may be the transaction request for the asset exchange of the user node 2. Here, the user node 2 may upload the price information on the actual asset exchange of the information collection node 3 on its own. The user node 2 may directly upload the price information on the actual asset exchange to the blockchain. The user node 2 may directly upload the price information on the actual asset exchange to the transaction apparatus 1 of the cryptocurrency. The user may pay additional Tx fees when requesting the transaction. Nonetheless, the user may still a benefit from the ability to be transacted at real-time prices. When assuming a typical transaction volume, the total Tx fees for the manager and the user in the cryptocurrency exchange market may decrease. Thus, the cryptocurrency transaction market may be more activated. This is because it reduces costs of the manager in the cryptocurrency exchange market.

The information collection node 3 may provide the price information on the actual asset exchange for each block. The block may contain visual information. For example, a 11 o'clock block may include price information on an actual asset exchange at about 11 o′clock and time information of about 11 o'clock. Thereafter, the block at about 11:01 may include price information of an actual asset exchange at about 11:01 and time information of about 11:01. Here, the price information on the actual asset exchange may be changed every minute.

The information collection node 3 may provide the price information on the actual asset exchange to the user node 2 for each block. When the information collection node 3 provides the price information on the actual asset exchange to the user node 2, the information collection node 3 may include an authentication method using a digital signature algorithm (DSA). Thus, the user may prevent fake price values being input.

The user node 3 may transmit the transaction request what it wants and the price information on the actual asset exchange that is a target of the transaction request to the transaction apparatus 1 of the cryptocurrency. Here, the Tx fees may occur.

The transaction apparatus 1 of the cryptocurrency may perform an operation corresponding to the transaction request of the user node. The transaction apparatus 1 of the cryptocurrency may perform verification of the digital signature. The transaction apparatus 1 of the cryptocurrency may determine that the information is fake if the verification is not performed properly. In this case, the transaction may not be performed. The transaction apparatus 1 of the cryptocurrency may update the price information on the actual asset exchange when the verification is performed correctly. The transaction apparatus 1 of the cryptocurrency may evaluate a risk of the impermanent loss (IL) using the price information on the actual asset exchange. The transaction apparatus 1 of the cryptocurrency may execute or reject the transaction request of the user node depending on a risk level. The risk may be determined to be greater as the more the price information on the actual asset exchange is past information. When the risk level exceeds a certain critical value, the user node's transaction request may be rejected.

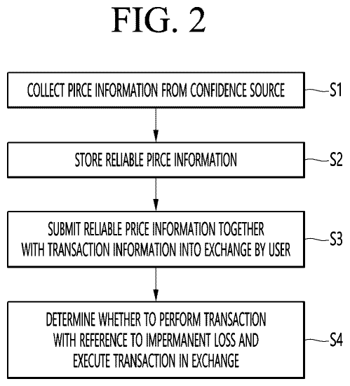

FIG. 2 is a flowchart for explaining a management method for the transaction apparatus of the cryptocurrency according to the present disclosure.

Descriptions will be made with reference to FIG. 2. The information collection node 3 may collect the price information on the actual asset exchange from the confidence information provision node 4 (S1). The price information on the actual asset exchange may be reliable information. The information collection node may collect new information whenever the price information on the actual asset exchange is changed. The information collection node may collect new information for each block.

The information collection node may store the price information on the collected actual asset exchange (S2). The information collection node may store the price information on the actual asset exchange for each block.

The user node 2 may request the transaction of its own cryptocurrency (S3). Here, the user node may acquire the price information on the actual asset exchange from the information collection node 3. The user node may submit the acquired information to the transaction apparatus 1 of the cryptocurrency. The user may incur certain transaction fees when using the blockchain. The transaction costs may include Tx fees. The transaction costs may be significantly lower than a cost of the transaction apparatus of the cryptocurrency, which updates the price information on the real asset exchanges every block.

The transaction apparatus 1 of the cryptocurrency may determine whether to perform or not transaction by referring to the impermanent loss (S4). The transaction apparatus 1 of the cryptocurrency may verify the digital signature and reject the transaction if the verification is not successful. The transaction apparatus 1 of the cryptocurrency may set an allowable range for the impermanent loss. The transaction apparatus 1 of the cryptocurrency may limit an amount of impermanent loss that may occur. The impermanent loss may be greater as the more the price information of actual asset exchange is past information. For example, when the current time is about 11:15, the impermanent loss may be greater in a second case, in which the price information on the actual asset exchange is at about 11:11, than in a first case, in which the price information on the actual asset exchange is at about 11:13. The allowable range for the impermanent loss will be set below. A time delay between a current time and a time at which the price information of the actual asset exchange is changed may occur due to network delay or operation priority of the blockchain. If all the transactions are rejected when there is even one second of time delay, usability of the cryptocurrency exchange may be significantly reduced. If the time delay allowed all the transactions to proceed even for about one hour, the impermanent loss may dramatically increase. Thus, the allowable range may be set.

The transaction apparatus 1 of the cryptocurrency may be used based on the verification of the digital signature and the allowable range of the impermanent loss. The transaction apparatus 1 of the cryptocurrency may execute the transaction request of the user node if the criteria are satisfied. The executed transaction information may be transmitted to the user node.

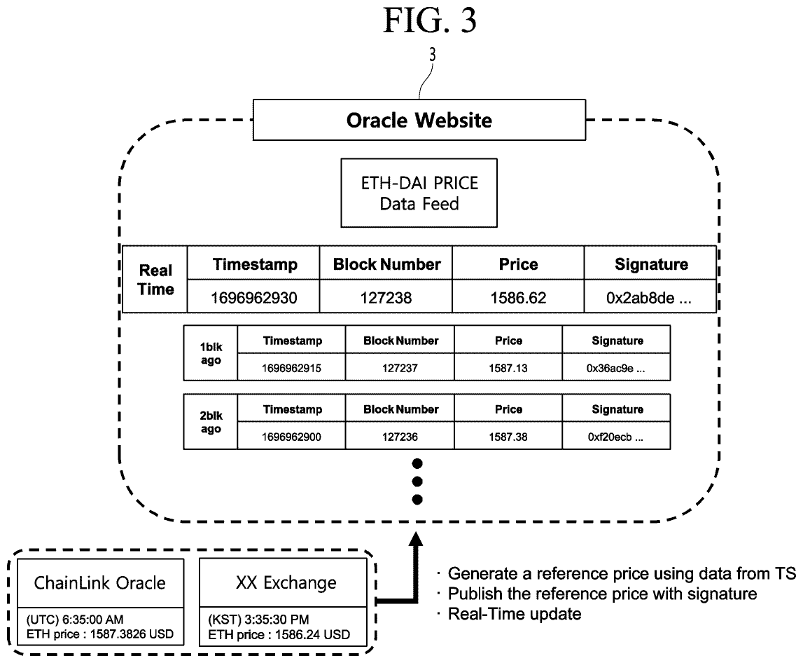

FIGS. 3 and 4 are views for explaining an operation of each node, and FIG. 3 is a view for explaining an operation of the information collection node. FIG. 4 is a view for explaining an operation of the user node. In the explanation, the price information on the actual asset exchanges is given as an example of Ethereum and Dai.

This will be described with reference to FIGS. 3 and 4. The information collection node may collect information from at least two confidence information provision nodes 4. The information collection node may generate a block whenever the price information on the actual asset exchange is changed. The block may include a timestamp, a block number, price information on the actual asset exchange, and a digital signature.

The user node may obtain information about the block from the information collection node. The user node may generate transaction request information. The transaction request information may include various pieces of information such as a cryptocurrency being sold, a cryptocurrency being purchased, and a transaction deadline. The user node may transmit the block information together with the transaction request information to the transaction apparatus of the cryptocurrency. The information in the block may include the price information on the actual asset exchange. The price information on the actual asset exchange may be reliable information. As already described, the price information on the actual asset exchange may need to be verified again with respect to the time.

FIG. 5 is a view illustrating a configuration of the transaction apparatus of the cryptocurrency.

Descriptions will be made with reference to FIG. 5. The transaction apparatus of the cryptocurrency may include a verification unit 12 that verifies the digital signature. The digital signature may be stored in the information of the block. The transaction apparatus of the cryptocurrency may include a public key storage unit 11 that stores a public key corresponding to a key of the digital signature. When the verification in the verification unit 12 fails, a rejection sequence unit 17 may be performed to reject the transaction request. The rejection sequence may include a notification procedure for the user node 2 for the fact that the transaction request has been rejected and the reason for the rejection.

When the verification is completed in the verification unit 12, an update may be performed in an update unit 13. The update unit 13 may update information in response to the timestamp included in the information of the block. The updated information may include the price information on the actual asset exchange.

The update unit may receive the block information from at least two user nodes 2. The update unit may be updated using information of the block from the user node currently requesting the transaction. The update unit may use the information of the previously stored block and may not currently be updated. For example, the current time may be about 11:00, the information of the block previously stored may be about 10:57, and the information of the block from the user node requesting the current transaction may be about 10:55. In this case, the price information on the actual asset exchange corresponding to the information of the block previously stored may be output. This is because the impermanent loss is further less in the information of the block, which is stored previously. The update unit may always have the latest block information. The updated and output information 14 may be input into an impermanent loss measurement unit 15. This information may be used in an analysis of the following Equation 1. The information output here may include some of the information of the block and the transaction request information. The impermanent loss measurement unit 15 may measure the impermanent loss that may occur when performing the current transaction request.

The impermanent loss measurement unit 15 may receive current transaction request information and block information output from the verification unit. The impermanent loss measurement unit 15 may measure the impermanent loss of the currently requested transaction request using the block information.

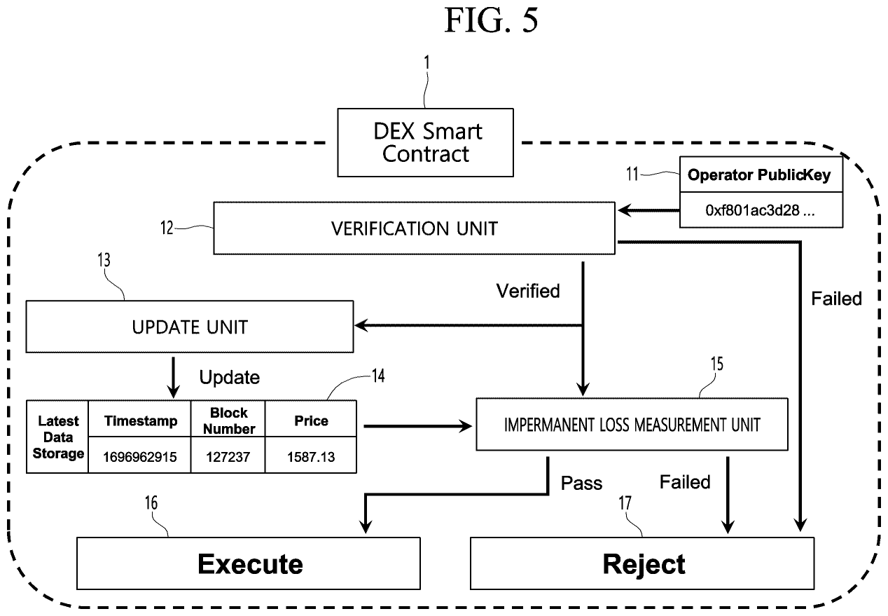

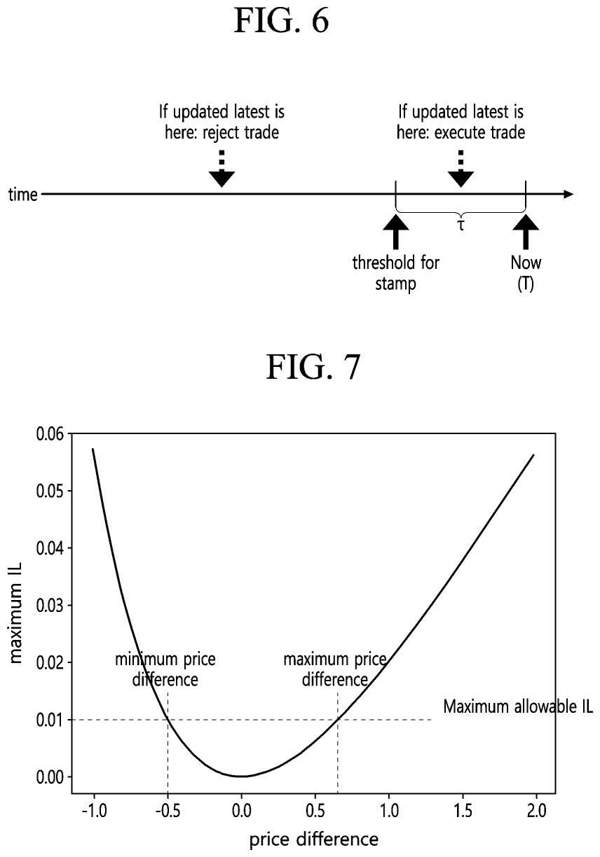

An operation of the impermanent loss measurement unit will be described with reference to FIGS. 6 and 7. FIG. 6 is a timeline illustrating a critical range that allows for delay in transaction request. FIG. 7 is a view illustrating a maximum allowable value of the impermanent loss.

This will be described with reference to FIGS. 6 and 7. It may have an allowable range t of an allowable delay time at the current time T. When the timestamp of the transaction request is within the allowable range, the transaction may be permitted. When the timestamp of the transaction request is outside the allowable range, the transaction may not be permitted. The larger the allowable range τ of the delay time, the greater the impermanent loss. The larger the allowable range τ of the delay time, the greater possibility of transaction realization. When the allowable range τ of the delay time is small, the impermanent loss may be small. The smaller the allowable range t of the delay time, the lower the possibility of the transaction realization. For example, the timestamp of the information in the block for which the current transaction is requested may be within an allowable critical range. That is, the transaction-requested timestamp may be in the range of (T−τ) to T. In this case, the execution sequence unit (see reference numeral 16 in FIG. 5) that executes the transaction may be performed. For example, the timestamp in the information of the block for which the current transaction is requested may be out of the allowable critical range. That is, the transaction-requested timestamp may be in the range of (T−τ) or less. In this case, the rejection sequence unit (see reference numeral 17 in FIG. 5) that rejects the transaction may be performed.

The allowable range of the delay time may correspond to a maximum allowable value (ILmax) of the impermanent loss. Referring to FIG. 7, the larger the allowable range of delay time, the larger a size of a difference due to the difference transaction. In other words, an increase in allowable range for delay time may correspond to an increase in allowable range for difference due to the difference transaction. Similarly, a smaller allowable range for the delay time may correspond to a smaller allowable range for the difference transaction.

It will refer again to FIG. 5. If the measurement results of the impermanent loss measurement unit 15 shows that the impermanent loss exceeds the maximum allowable value, the transaction request may be rejected and shifted to the rejection sequence unit 17. If the measurement results of the impermanent loss measurement unit 15 shows that the impermanent loss does not exceed the maximum allowable value, the transaction request may be executed and shifted to the execution sequence unit 16.

The information of the latest first block updated in the update unit 13 and transmitted to the impermanent loss measurement unit may not match information of a second block corresponding to the transaction request transmitted from the verification unit 12. In this case, the transaction apparatus for the cryptocurrency may measure the impermanent loss using the information of the first block and inquire the user node 2 whether to perform the transaction using the information of the first block. The transaction apparatus for the cryptocurrency may determine whether to perform the transact cryptocurrency or not based on the user node's selection after the inquiry.

The allowable range τ of the delay time will be described in detail. Equation 1 shows the allowable range of the delay time.

$$c τ σ \leq p ( T - τ ) \{ - {IL}_{max} + 2 \sqrt{{IL}_{max}} \} \qquad [ Equation 1 ]$$

$$τ \leq \frac{p ( T - τ )}{c σ} \{ - {IL}_{max} + 2 \sqrt{{IL}_{max}} \}$$

Here, P may mean an actual price, P(T−τ) may mean a price at time (T−τ), and P(T) may mean a price at T (current time). IL may mean an impermanent loss. ILmax may be a maximum allowable impermanent loss. c may represent a standard score for setting a confidence interval. σ may mean a standard deviation.

For example, it is assumed that P(T−τ) be about $3,000, σ be about $3, and c be about 1.96. Here, if σ is set to 10 blocks, the maximum allowable impermanent loss may be about 0.01%. If t is set to 32 blocks, the maximum allowable impermanent loss may be about 0.1%. As the allowable range of the delay time increases, the maximum allowable impermanent loss may increase. Referring to Equation 1, as the maximum allowable impermanent loss increases, the allowable range of the delay time may increase. The larger the confidence interval, the smaller the allowable range of the delay time. As the standard deviation increases, the allowable range of the delay time may decrease. The higher the price, the greater the allowable range for the delay time.

Equation 1, which is a relational Equation for the allowable range of the delay time, will be described.

Real-time price information P(T) may be predicted using the price information P(T−τ) prior to the given delay time τ. When the price change follows an auto regressive integrated moving average (ARIMA) model (p, d, q), the price change model may be as shown in Equation 2.

$${\hat{p}}_{t} ( T ) - c \sqrt{{σ}^{2} ( τ , T )} \leq p ( T ) \leq {\hat{p}}_{t} ( T ) + c \sqrt{{σ}^{2} ( τ , T )} \qquad [ Equation 2 ]$$

$${\hat{p}}_{t} ( T ) : price at time T , predicted using prices observed at ( T - t ) , \\ ( T - t - 1 ) , …$$

$${σ}^{2} ( τ , T ) : variance of prediction$$

$$c : constant for the given confidence level$$

Here, the price information requested for the transaction is P(T−τ), but the actual price is P(T). Arbitrage using a difference between the two prices may occur, and the resulting impermanent loss may occur. When there are x amount of asset X and y amount of asset Y in a pool of the transaction market, and the price difference is defined as ρ=P(T)/P(T−τ), the impermanent loss due to this price difference may be defined as in Equation 3.

$$\begin{matrix}IL ( ρ ) := \{ Value of pool after arbitrage \} - \\ \{ Value of exiting pool \} \\ = ( 1 + ρ ) - 2 \sqrt{ρ} \\ = {( 1 - \sqrt{ρ} )}^{2}\end{matrix} \qquad [ Equation 3 ]$$

Thus, a maximum possible impermanent loss may be defined as in Equation 4.

$${IL}_{max} = \{ \begin{matrix}{( 1 - \sqrt{{ρ}_{max}} )}^{2} , & if ρ > 1 , \\ {( 1 - \sqrt{{ρ}_{min}} )}^{2} , & if ρ < 1\end{matrix} .$$

If the price difference ρ is expressed as the maximum impermanent loss (ILmax), it may be expressed as Equation 5.

$${ρ}_{max} \leq 1 + 2 \sqrt{{IL}_{max}} + {IL}_{max} , and \qquad [ Equation 5 ]$$

$${ρ}_{min} \geq 1 - 2 \sqrt{{IL}_{max}} + {IL}_{max}$$

When the price difference ρ=P(T)/P(T−τ) is substituted into Equation 5, and the number of identical delay-allowable maximum blocks τ equivalent to the given allowable delay time τ is expressed as a function of the maximum impermanent loss (ILmax), it may be as shown in Equation 6.

This is because the delay time is proportional to the number of blocks.

$$μ ( τ , T ) + c \sqrt{{σ}^{2} ( τ , T )} \leq p ( T - τ ) ( 2 \sqrt{{IL}_{max}} + {IL}_{max} ) , \qquad [ Equation 6 ]$$

$$and$$

$$μ ( τ , T ) - c \sqrt{{σ}^{2} ( τ , T )} \geq p ( T - τ ) ( - 2 \sqrt{{IL}_{max}} + {IL}_{max} ) ,$$

$$where μ ( τ , T ) = {\hat{p}}_{τ} ( T ) - p ( T - τ ) is drift .$$

If learning with the ARIMA model (p=1, d=0, q=0) using Equation 6, Equation 1 may be presented because σ(τ, T)=τσ.

Four relationships may be established by Equation 1. First, as the maximum allowable impermanent loss increases, the allowable range for the delay time may increase. Second, the larger the confidence interval, the smaller the allowable range of the delay time. Third, as the standard deviation increases, the allowable range of the delay time may decrease. Fourth, the larger the price, the greater the allowable range for the delay time. The four relationships may be the same even though the regression analysis model is AR, MA, or ARMA.

According to the present disclosure, the transaction of the cryptocurrency may be promoted by at least one of the reduction of the impermanent loss (IL), the reduction of the transaction fee the loss of the of cryptocurrency, or cryptocurrency exchange market manager.

### INDUSTRIAL APPLICABILITY

According to the present disclosure, the impermanent loss may be reduced at the low cost. Therefore, it may promote the cryptocurrency transaction.

What is claimed is:

1. A digital asset transaction system comprising:
a verification unit configured to input information of a block including an asset, for which a transaction request is performed, price information for exchanging the asset, a timestamp, and a digital signature, and perform verification of the digital signature;
an update unit configured to update the latest information on the current time of the asset by using the information contained in the information of the block; and
an impermanent loss measurement unit configured to measure an impermanent loss corresponding to a delay time, which is a difference between the delay time corresponding to the timestemp and the current time, by using the information of the block output from the verification unit, and configured to determine whether to perform a transaction of the asset in response to the transaction request by using the measured impermanent loss.

2. The digital asset transaction system according to claim 1, wherein the transaction request, in which a user requests the transaction, is transmitted to the verification unit together with the information of the block.

3. The digital asset transaction system according to claim 1, further comprising:
a rejection sequence unit configured to reject the transaction request in at least one of a case, in which the verification of the digital signature fails in the verification unit, or a case, in which the impermanent loss measured in the impermanent loss measurement unit exceeds a maximum allowable value of the impermanent loss; and
an execution sequence unit configured to execute the transaction request when it is satisfied that the digital signature is verified in the verification unit, and the impermanent loss measured in the impermanent loss measurement unit does not exceed the maximum allowable value of impermanent loss.

4. The digital asset transaction system according to claim 1, wherein the impermanent loss measurement unit is configured to measure the impermanent loss that occurs when executing the transaction request using the latest information output from the update unit.

5. The digital asset transaction system according to claim 1, wherein the determination of whether to perform the transaction of the asset comprises satisfaction of at least one of a case, in which as the maximum allowable impermanent loss increases, an allowable range for the delay time increases, a case, in which the larger a confidence interval, the smaller the allowable range of the delay time, a case in which as a standard deviation increases, the allowable range of the delay time decreases, or a case in which the larger a price of the asset, the greater the allowable range of the delay time.

6. The digital asset transaction system according to claim 1, further comprising:
at least one confidence information provision processor configured to provide reliable price information of the asset;
information collection processor configured to collect price information on actual asset exchange of the asset from the confidence information provision processor; and
a user processor configured to acquire the price information of the actual asset exchange from the information collection processor and transmit the acquired price information to the verification unit in order to request the transaction of the asset as necessary.

7. A digital asset transaction method comprising:
allowing an information collection processor to collect price information of digital asset exchange from a confidence information provision processor and store the collected actual price information of the digital asset exchange;
allowing a user processor to acquire the actual price information of the digital asset exchange from the information collection processor in order to require the price information of transaction of a digital asset and submit the transaction required of the digital asset and the price information of the digital asset exchange together to a transaction processor; and
determining whether to perform the transaction by referring an impermanent loss.

8. The digital asset transaction method according to claim 7, further comprising:
acquiring the price information of the digital asset exchange at a first time point at which the digital asset transaction is requested; and
submitting the price information of the digital asset exchange to the transaction processor.

9. The digital asset transaction method according to claim 8, wherein the transaction processor is configured to measure the impermanent loss, which occurs due to a time delay between the first time point and a second time point, at the second time point at which the impermanent loss is measured.

10. The digital asset transaction method according to claim 9, wherein the transaction processor is configured to reject the transaction in either case, in which verification of the digital signature fails, or case, in which the impermanent loss exceeds an allowable range of the impermanent loss.

11. The digital asset transaction method according to claim 9, wherein an allowable range of the delay time comprises satisfaction of at least one of a case, in which as the allowable impermanent loss increases, an allowable range for the delay time increases, a case, in which the larger a confidence interval, the smaller the allowable range of the delay time, a case in which as a standard deviation increases, the allowable range of the delay time decreases, or a case in which the larger a price of the asset, the greater the allowable range of the delay time.

12. A digital asset transaction method comprising:
operating by at least one first processor configured to collect information of a digital asset, at least one second processor configured to perform a transaction request of the digital asset, and at least one third processor configured to perform the transaction of the digital asset according to the information and the transaction request,
wherein the first processor is configured to:
collect price information of reliable asset exchange for the digital asset;
store the price information of the asset exchange; and
collect new information in response to changes in the price information of the asset exchange,
wherein the second processor is configured to:
obtain the price information of the asset exchange from the first processor;
request the transaction of the digital asset to the third processor; and
submit the price information of the asset exchange to the third processor when requesting the transaction of the digital asset,
wherein the third processor is configured to:
calculate an impermanent loss using the price information of the asset exchange; and
determine whether to transact the digital asset in response to the transaction request by referring to the impermanent loss.

13. The digital asset transaction method according to claim 12, wherein the first processor is configured to collect new information for each block of the digital asset.

14. The digital asset transaction method according to claim 12, wherein the third processor is configured to:
set an allowable range of the impermanent loss; and
reject the transaction when the calculated impermanent loss exceeds the allowable range of the impermanent loss.

15. The digital asset transaction method according to claim 12, wherein the third processor is configured to calculate the impermanent loss by using a delay time for a difference between first time information related to a time of the price information of the asset exchange provided by the second processor to the third processor and second time information related to a time at which the third processor calculates the impermanent loss.

16. The digital asset transaction method according to claim 15, wherein, as the maximum allowable impermanent loss increases, the allowable range of the delay time increases.

17. The digital asset transaction method according to claim 15, wherein the larger a confidence interval, the smaller the allowable range of the delay time.

18. The digital asset transaction method according to claim 15, wherein as a standard deviation increases, the allowable range of the delay time decreases.

19. The digital asset transaction method according to claim 15, wherein, in the allowable range of the delay time, the higher a price of the asset, the greater the allowable range of the delay time.

20. The digital asset transaction method according to claim 12, wherein, when first price information, which is price information of the asset exchange at a first time provided by the second processor to the third processor, and second price information, which is price information of the asset exchange at the first time, which is contained in the third processor, are different from each other, the third processor is configured to:
inquire about selection of the second price information by the second processor; and
determine selection of the second price information by the second processor and transmit the selected price information to the third processor.
